(19) United States
(12) Patent Application Publication
(10) Pub. No.: US 2018/0106571 A1
(43) Pub. Date: Apr. 19, 2018

(54) DEVICE FOR CLEANING SMALL SPACES

(71) Applicant: James Hanlin, Anchorage, WA (US)

(72) Inventor: James Hanlin, Anchorage, WA (US)

(21) Appl. No.: 15/293,205

(22) Filed: Oct. 13, 2016

(51) Int. Cl. F41A 29/02; B25G 3/36

(52) U.S. Cl. CPC F41A 29/02; B25G 3/36

(57) ABSTRACT

A cleaning rod piece configured to extend the reach of standard small-space cleaning tools. Also configured to securely hold the cleaning element, such as a cotton plug or swab, at a 90 degree angle to the rod, allowing firmer pressure against the surface to be cleaned. The secure holding may be accomplished by compression fitting the cleaning element into a hole in the rod portion. Alternatively, the rod portion may include threads into which the cleaning element can be threaded, thereby securing the element to the rod portion. The piece is typically configured to enter small spaces, and will usually be between five and ten millimeters in total diameter. May include an adapter region threaded to fit into a standard 8-32 or 8-36 cleaning rod.

### FIELD OF THE INVENTION

This invention relates generally to cleaning, and, more specifically, to devices for cleaning small spaces.

### BACKGROUND OF THE INVENTION

Many attempts have been made to create cleaning devices for articles like firearms, which can have extended lengths of small open spaces, such as the portion of the barrel near the ejection port on an AR 15, or instruments such as clarinets, oboes, and flutes, which can develop mold and buildup if not cleaned thoroughly. Through these many attempts, similar problems kept arising. Either the cleaning rod is too short to reach the targeted area, the rod is unable to securely hold the cleaning means, which is usually a simple cotton plug or a length of cloth, or the targeted area is difficult to see, which exacerbates the first two problems. These are just some of the problems which the present invention aims to overcome.

### SUMMARY OF THE INVENTION

This invention relates generally to cleaning, and, more specifically, to devices for cleaning small spaces.

Disclosed is a device configured to fit within very small spaces, such as the barrel of a long firearm. The device is further configured to securely hold a cleaning means such that the cleaning means can be pressed firmly against rigid portions of the area to be cleaned without becoming dislodged. The device may include a threaded lower portion such that it can be coupled with a threaded rod, the threaded rod configured to extend the reach of the device. The device may include a magnetic coupling mechanism for coupling to the rod, a compression or click mechanism, or the device itself may be sufficiently long such that it can reach down the barrel of long firearms. The device may include at least one hole or recess into which the cleaning means can be inserted, and the hole or recess may be threaded to more securely hold the cleaning means. The hole may be configured to receive a standard sized cotton swab, wherein the stem of the swab is inserted into the hole. The hole may be configured to hold the cleaning means by virtue of compression.

The foregoing is a summary and thus contains, by necessity, simplifications, generalizations and omissions of detail; consequently, those skilled in the art will appreciate that the summary is illustrative only and is NOT intended to be in any way limiting. Other aspects, embodiments, features and advantages of the device and/or processes and/or other subject matter described herein will become apparent in the teachings set forth herein.

### BRIEF DESCRIPTION OF THE DRAWINGS

Certain embodiments of the present invention are described in detail below with reference to the following drawings:

FIG. 1 is an isometric view of one embodiment of the rod extender with a cleaning means in place;

FIG. 2 is a side view of one embodiment of the rod extender;

FIG. 3 is a top view of one embodiment of the rod extender;

FIG. 4 is an isometric environmental view of one embodiment of the rod extender in use; and

FIG. 5 is a magnified view of the environmental view of FIG. 4.

### DETAILED DESCRIPTION

This invention relates generally to cleaning, and, more specifically, to devices for cleaning very small spaces.

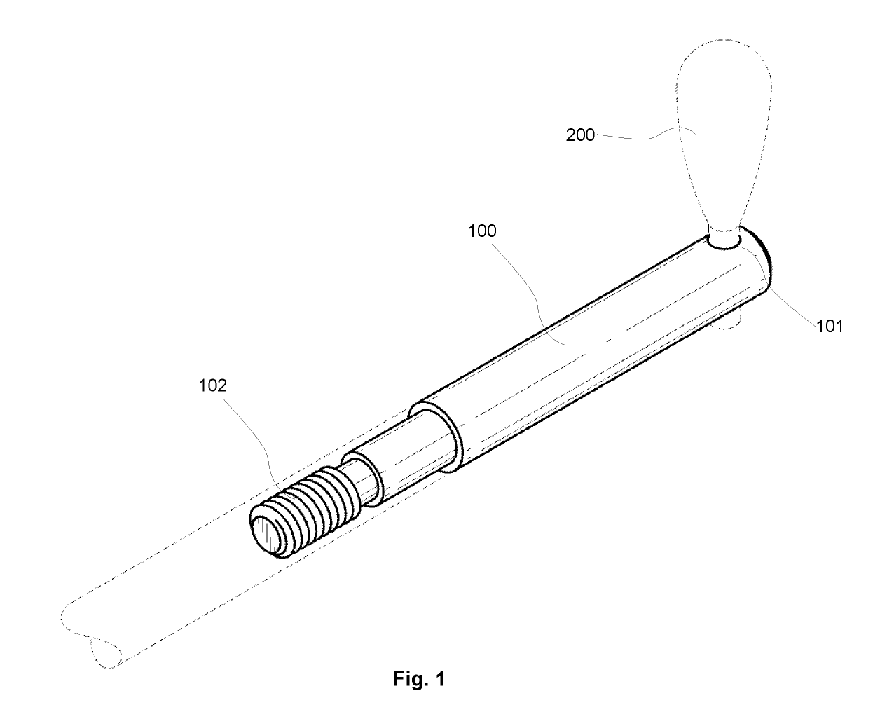

Specific details of certain embodiments of the invention are set forth in the following description and in FIGS. 1-5 to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is an isometric view of one embodiment of the device for cleaning very small spaces. The device may comprise a rod portion 100, a portion 101 for holding a cleaning means 200, and a coupling portion 102.

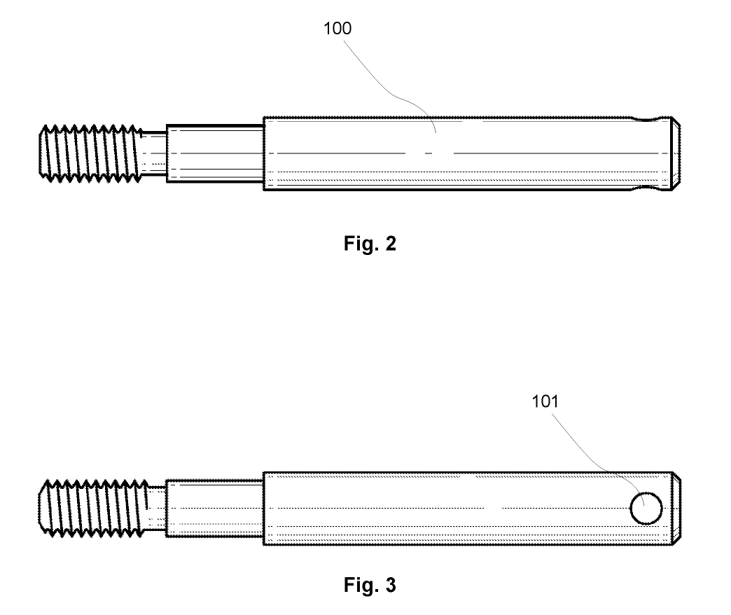

Turning now to FIG. 2, in some embodiments, rod portion 100 may be relatively short, on the order of one to four inches, such that it can be coupled with standard cleaning rods and easily carried in a pack or on the user. In other embodiments, rod portion 100 may be relatively long, on the order of 12 inches or more, such that it can be used as a standalone product without being coupled to standard cleaning rods. The rod portion 100 will generally be of a smaller diameter, typically around 0.203 inches or approximately five millimeters. It may be slightly smaller or larger, but will typically be between three millimeters to one centimeter in diameter.

FIG. 3 is a side view of one embodiment of the device, which may further include a hole or recess for holding a cleaning means. Hole 101 may be configured to hold a cleaning means by compression. For example, hole 101 may sufficiently small that it can securely grip a stem of a standard cotton swab, such as 7/64 of an inch. In other embodiments, hole 101 may include threads, wherein the stem of the cotton swab or another cleaning means would be threaded into the hole, the threads preventing the cleaning means from being pushed out of place when the cleaning means is pressed firmly against a substantially rigid surface. In threaded embodiments, the hole 101 may be threaded with 4-40 threads. In alternative embodiments, hole 101 may instead be a recess, wherein the internal portion of the recess is configured to securely receive a cleaning means. In one example, recess 101 may include a reusable adhesive, such that cleaning means can be inserted, used, removed, without reducing the efficacy of the adhesive. In other embodiments, recess 101 may be configured to receive a temporary adhesive prior to insertion of the cleaning means. In still other embodiments, recess 101 may be magnetized and used in conjunction with a magnetic cleaning mechanism such that the magnetic attraction between the device and the cleaning mechanism is sufficient to hold the mechanism in place when the cleaning means, coupled with the mechanism, is pressed firmly against a substantially rigid surface.

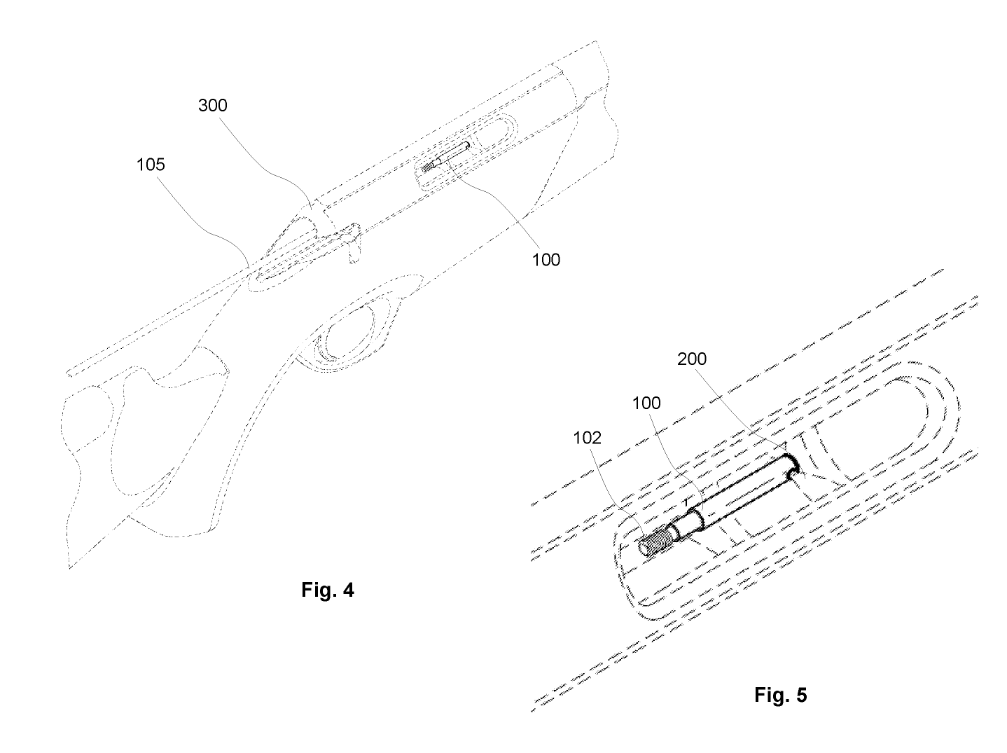

FIG. 4 is an environmental isometric view of the device coupled with a standard cleaning rod 105 and in use in a firearm 300. In this embodiment, rod portion 100 is coupled with the cleaning rod 105 with either a standard 8-32 or 8-36 threaded adapter. FIG. 5 is a magnified view thereof. This is one non-limiting example of one use of the device. Some firearms have barrels that are difficult to clean from the front, due to their length, and difficult to clean from the rear due to the very small spaces and tight mechanisms associated with firearms. Being able to use a very small cleaning means 200, such as the end of a cotton swab, enables a user to clean otherwise difficult to reach mechanisms at the rear of the firearm. Moreover, because hole 101 is configured to firmly hold the cleaning means 200, the user does not risk losing the cleaning means in the mechanism of the firearm or having to repeatedly begin again after retrieving a cleaning means that has fallen out.

The device is shown in FIG. 4 coupled with a standard firearm cleaning rod. In a preferred embodiment, the portion of the device opposite hole 101 is threaded, which allows the device to be removably coupled with standard cleaning rods 105. The threads will typically be a standard 8-32 or 8-36. However, the coupling portion 102 may, in some embodiments, be configured for coupling via other means. For instance, coupling portion 102 may be magnetic, such that it is removably coupled to the rod 105 via magnetic forces. Coupling portion 102 may be configured to fit over and receive the end of a rod 105, holding the rod via compression or friction forces. In some embodiments, the coupling portion 102 may either receive or be received by the rod 105 and, in combination, rely partially on magnetic forces to keep the device and the rod coupled during use. In still other embodiments, the device itself may be long enough to function as the rod.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

While preferred and alternative embodiments of the invention have been illustrated and described, as noted above, many changes can be made without departing from the spirit and scope of the invention. Accordingly, the scope of the invention is not limited by the disclosure of these preferred and alternate embodiments.

What is claimed is:

1. A cleaning device, comprising:
a short rod having a first end and a second end, wherein the first end is configured to be removably coupleable with a standard cleaning rod, and
wherein the second end includes at least one hole, wherein the at least one hole is configured to securely receive at least one cleaning means.

2. The device of claim 1, wherein the first end configured to be removably coupleable with a standard cleaning rod is threaded.

3. The cleaning device of claim 2, wherein the threads are on an outside surface of the short rod.

4. The cleaning device of claim 1, wherein the hole configured to securely receive at least one cleaning means is threaded on an inside perimeter of the hole.

5. The cleaning device of claim 1, wherein the hole configured to securely receive at least one cleaning means is 7/64 inch in diameter.
